(19) United States
(12) Patent Application Publication
(10) Pub. No.: US 2016/0210813 A1
(43) Pub. Date: Jul. 21, 2016

(54) SYSTEM AND METHOD FOR PERFORMING A STREAK WAGERING GAME

(71) Applicant: WMS Gaming Inc., Waukegan, IL (US)

(72) Inventors: ANTHONY BAERLOCHER, HENDERSON, NV (US); ALLON G. ENGLMAN, CHICAGO, IL (US)

(21) Appl. No.: 14/599,706

(22) Filed: Jan. 19, 2015

(51) Int. Cl. G07F 17/32

(52) U.S. Cl. CPC G07F 17/3225; G07F 17/3286; G07F 17/3211; G07F 17/3276

(57) ABSTRACT

A gaming system includes game-logic circuitry performing a wagering streak game providing payouts in accordance with the ability for a player to accurately predict the outcome of another ancillary game. When the player accurately predicts the outcome of the ancillary game, an accuracy streak is formed that continues until the player fails to accurately predict an ancillary game outcome. Multiple players may simultaneously play streak games independently from one another, and a single player may simultaneously participate in multiple streak games dependent upon the same ancillary game. A player can begin, suspend, and resume a streak game at any time during selection of an upcoming outcome state for the ancillary game. Multiple players may also simultaneously participate in the streak game collectively, distinct from any participation in the ancillary game, by independently determining the accuracy streak using criteria common for all players (e.g., a common opponent or predefined condition).

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming apparatus and methods and, more particularly, to a system utilizing outcomes of an ancillary game to provide a streak wagering game.

### BACKGROUND OF THE INVENTION

The gaming industry is a multi-billion dollar industry that depends upon player participation. Gaming machines, such as slot machines, video poker machines and the like, have been a cornerstone of the gaming industry for several years. Players are generally “hopeful” players who either think they are lucky or at least think they can get lucky—for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. This luck factor is what appeals to core players. As the industry matures, the creativity and ingenuity required to improve such operation of gaming apparatus and games grows exponentially.

### SUMMARY OF THE INVENTION

According to one aspect of the present invention, a gaming system primarily dedicated to playing a regulated casino wagering game including predicting outcomes of an ancillary game is disclosed. The gaming system comprises an input interface for receiving input signals via a communications network, an output interface for transmitting output signals via the communications network, a random element generator configured to generate one or more random elements, and game-logic circuitry. The game-logic circuitry is configured to initiate and perform the casino wagering game in response to receiving a wager input signal indicative of a wager by a player. The casino wagering game includes receiving a selection input signal indicative of a selection of a predicted outcome of the ancillary game. The predicted outcome is selected from a plurality of potential outcomes of the ancillary game. The game-logic circuitry determines an outcome of the ancillary game based, at least in part, on the one or more random elements, and transmits game data representing the outcome of the ancillary game for display on a remote device via the communications network. In response to the predicted outcome matching the determined outcome of the ancillary game, a streak counter is incremented and the streak counter is transmit, via the output interface, game data representing an increased value of the streak counter for display on the remote device. In response to the predicted outcome not matching the determined outcome, the game-logic circuitry grants an award to the player in response to meeting a predetermined award criterion for a value of the streak counter during conclusion of the casino wagering game.

According to one aspect of the present invention, a gaming system primarily dedicated to conducting a first and a second regulated casino wagering streak game using outcomes of a common ancillary game is disclosed. The gaming system includes at least one input interface for receiving first input signals and second input signals, at least one output interface for transmitting output signals to one or more electronic display devices, a random element generator configured to generate one or more random elements, and game-logic circuitry. The game-logic circuitry is configured to initiate the first regulated casino wagering streak game in response to receiving, via at least one of the input interfaces, a first input signal indicative of a first wager by a first player. The game-logic circuitry is also configured to initiate the second regulated casino wagering streak game in response to receiving, via at least one of the input interfaces, a second input signal indicative of a second wager by a second player. The game-logic circuitry determines an outcome of the ancillary game based, at least in part, on the one or more random elements, and transmits, via the at least one output interfaces, game data representing the outcome of the ancillary game for display on the one or more electronic display devices. In response to the determined outcome meeting first predetermined success criteria, a first streak counter having a first value representing a current streak for the first player is incremented. Game data representing the first value is transmit, via the at least one output interface, to the one or more electronic display devices for display. In response to the determined outcome meeting second predetermined success criteria, a second streak counter having a second value representing a current streak for the second player is incremented. Game data representing the second value is transmit, via the at least one output interface, to the one or more electronic display devices for display. In response to the determined outcome not meeting the first predetermined success criteria and the value of the first streak counter meeting a predetermined award criterion, granting an award to the first player based on the value of the first streak counter. In response to the determined outcome not meeting the second predetermined success criteria and the value of the second streak counter meeting a predetermined award criterion, granting an award to the second player based on the value of the second streak counter.

According to another aspect of the invention, a computer-implemented method in a gaming system primarily dedicated to playing a regulated casino wagering game is disclosed. The gaming system includes a secure gaming server, a random element generator, game-logic circuitry, an input interface for receiving input signals, and an output interface for transmitting output signals. The computer-implemented method includes generating one or more random elements with the random element generator. A wager input signal indicative of a wager by a player is received via the input interface. A selection input signal indicative of a selection of a predicted outcome of an ancillary game is received via the input interface. The predicted outcome is selected from a plurality of potential outcomes of the ancillary game. An outcome of the ancillary game based, at least in part, on the one or more random elements, is determined, and game data representing the outcome of the ancillary game for display on a remote device is transmit, via the output interface. In response to the predicted outcome matching the determined outcome, the game-logic circuitry increments a streak counter, and transmit game data representing an increased value of the streak counter via the output interface to the remote device for display. In response to the predicted outcome not matching the determined outcome, the game-logic circuitry grants an award to the player based on a value of the streak counter at conclusion of the casino wagering game meeting a predetermined award criterion.

According to still another aspect of the invention, the above gaming system is incorporated into a single, free-standing gaming terminal.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present invention.

FIG. 2 is a schematic view of a gaming system according to an embodiment of the present invention.

FIG. 3 is an image of an exemplary basic-game screen of a wagering game displayed on a gaming machine, according to an embodiment of the present invention.

FIG. 4 is a block diagram illustrating a wagering-game system according to an embodiment of the present invention.

FIG. 5 is a flowchart for an algorithm for performing a streak wagering game in a gaming system, according to an embodiment of the present invention.

FIG. 6 is a flowchart for an algorithm for performing a streak wagering game for a plurality of players collectively participating in the streak wagering game, according to an embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

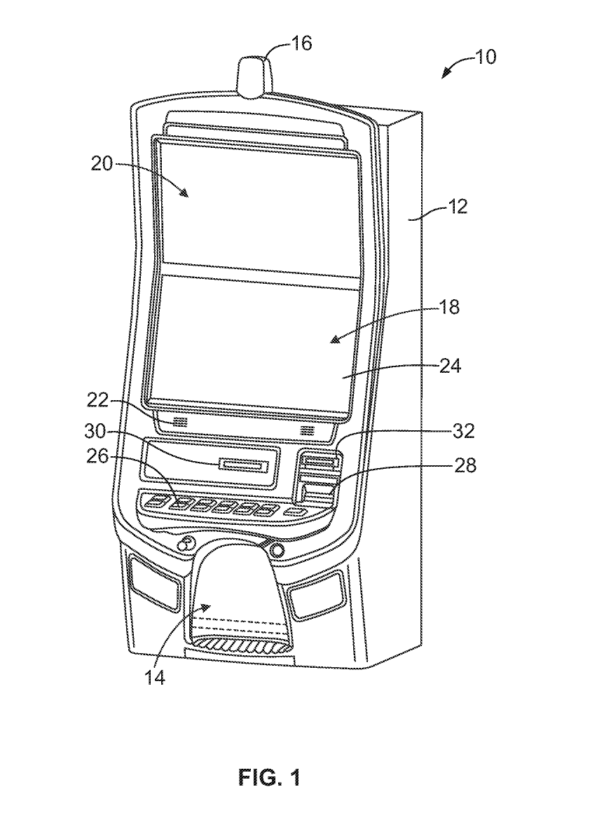

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. No. 6,517,433, U.S. Pat. No. 8,057,303, and U.S. Pat. No. 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary display 18, a secondary display 20, and one or more audio speakers 22. The primary display 18 or the secondary display 20 may be a mechanical-reel display device, a video display device, or a combination thereof in which a transmissive video display is disposed in front of the mechanical-reel display to portray a video image superimposed upon the mechanical-reel display. The displays variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 includes a touch screen(s) 24 mounted over the primary or secondary displays, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

The gaming machine 10 includes one or more value input/payment devices and value output/payout devices. The value input devices are used to deposit cash or credits onto the gaming machine 10. The cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. The value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

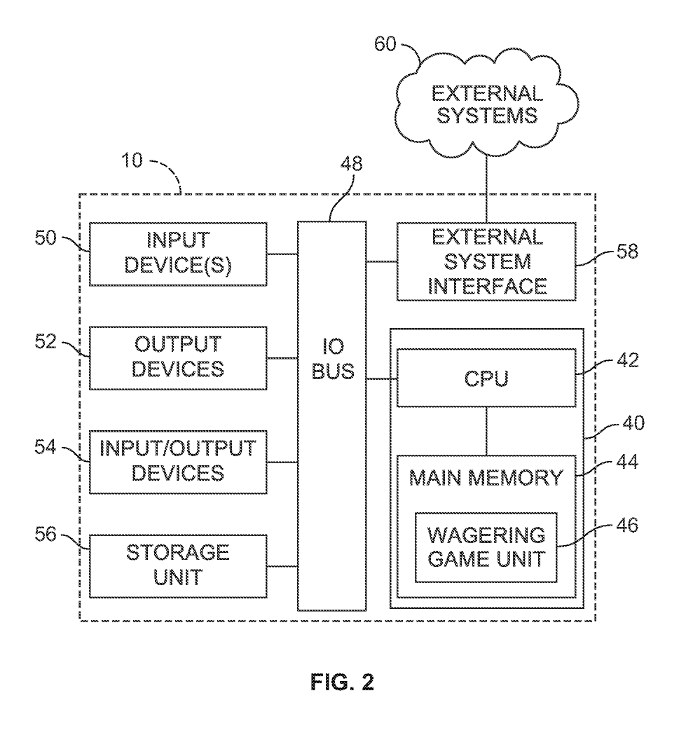

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video black jack, video slots, video lottery, etc., in whole or part.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compares it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player, for example, at a minimum of 100 Hz (100 calls per second) as set forth in Nevada's New Gaming Device Submission Package. Accordingly, the RNG cannot be carried out manually by a human.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

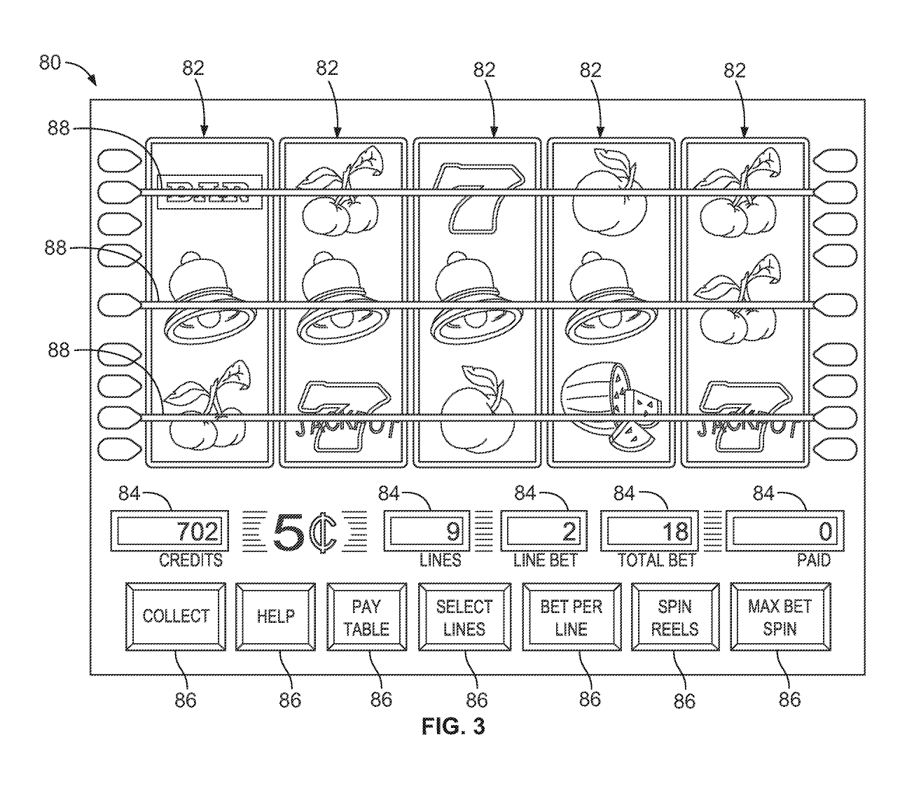

Referring now to FIG. 3, there is illustrated an image of a basic-game screen 80 adapted to be displayed on the primary display 18 or the secondary display 20 of a particular gaming machine 10. The basic-game screen 80 portrays a plurality of simulated symbol-bearing reels 82. Alternatively or additionally, the basic-game screen 80 portrays a plurality of mechanical reels or other video or mechanical presentation consistent with the game format and theme. The basic-game screen 80 also advantageously displays one or more game-session credit meters 84 and various touch screen buttons 86 adapted to be actuated by a player. A player can operate or interact with the wagering game using these touch screen buttons or other input devices such as the buttons 26 shown in FIG. 1. The game-logic circuitry 40 operates to execute a wagering-game program causing the primary display 18 or the secondary display 20 to display the wagering game.

In response to receiving an input indicative of a wager, the reels 82 are rotated and stopped to place symbols on the reels in visual association with paylines such as paylines 88. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary display 18 or secondary display 20) through the display of information such as, but not limited to, text, graphics, static images, moving images, etc., or any combination thereof. In accord with the method of conducting the wagering game, the game-logic circuitry 40 transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary display 18, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in other gaming jurisdictions. As can be seen from the description herein, the gaming machine 10 may be implemented with hardware and software architectures, circuitry, and other special features that differentiate it from general-purpose computers (e.g., desktop computers, laptops, and tablets).

Baccarat and other card games, for example Blackjack and Texas Hold 'Em, may generate an ongoing sequence of game outcomes (e.g., player wins, house wins, or ties). Further, other games including craps (and other dice games), BINGO (and other “ball” driven games), and video and/or mechanical slot machine devices, to name a few, may be used to provide a continuous sequence of game outcomes. Regardless of the specific game generating outcomes, game outcomes may be used as a basis for other types of wagering-game mechanics. The presently described wagering-game system uses outcomes of an ancillary game to provide a player an opportunity to monitor, wager on, and receive payouts in response to a series of successful predictions of the game outcome of the ancillary game, independent from any participation in the ancillary game itself.

In one embodiment, the invention specifically deals with a gaming system and method for performing a streak wagering game that enables players to predict the outcome(s) of an ancillary game and receive a payout corresponding to the number of consecutive correct predictions in a row. A ‘streak’ is defined as a sequence of the ancillary game outcomes (e.g., individual hands) where a player accurately predicts the outcome of the ancillary game. Alternatively, a streak may include a series of ancillary games or ancillary game hands that the player is actively participating in and avoids a loss in the ancillary game or hand.

In one embodiment, the duration of the streak wagering game is dependent upon the number of successful predictions of the game outcome of an ancillary game over the course of the streak wagering game. In another embodiment, a successful prediction involves a player achieving a winning, non-losing, or non-elimination condition for a hand, round, or result of the ancillary game. The goal for a player during the streak wagering game is to maximize the number of consecutive correct predictions (the “streak” of correct predictions) and extend the winning streak for as long as possible to obtain a higher payout. In some embodiments, this includes satisfying predetermined criteria, for example, the player achieving a minimal game payout, or a specified one of a set of game outcomes. Once the streak ends, the streak wagering game ends, and the player is granted an award amount indicated in the pay table corresponding to the length of the streak that the player achieved. The award amount granted to the player may be a concrete and tangible award, such as coins or tokens, or be granted in another form, including one or more types of virtual or physical payouts that may include currency.

One embodiment describes a streak wagering game using the ancillary card game Baccarat to generate outcomes. After a player indicates a prediction and places a wager, the subsequent Baccarat game outcomes are compared to the player's prediction for forming streaks in the streak wagering game. However, the invention is not limited to the use of Baccarat or any other particular ancillary game to generate outcomes. It is recognized that any ancillary game, wagering or non-wagering, may be used in conjunction with the described inventive process. Any game providing a series of outcomes for two distinct entities (e.g., WINS for the HOUSE or PLAYER), with or without TIE conditions, may be used to conduct a streak wagering game in accordance with the described disclosure. For example, various card games (e.g., Baccarat, Texas Hold 'Em poker, Blackjack) may be used to generate predictable outcomes, in addition to dice games (e.g., craps), ball driven games (e.g., BINGO), and/or video/mechanical games (e.g., slot machines). That is, any suitable game may be used to generate a series of randomized game outcomes for comparison to a set of available player predictions to generate streaks for the streak wagering game.

When there are multiple players participating in or using a common ancillary game generating game outcomes, predetermined common criteria may be shared among all the players for determining success for each respective prediction. For example, when a number of players are collectively participating in (or relying upon the outcome of) a Texas Hold 'Em poker game, most poker games (i.e., hands) are expected to conclude having a single player as the winner of the game. While using predetermined common criteria shared among all the players (e.g., the dealer's hand, or a fixed threshold rank like “three-of-a-kind or better”), each player of the streak wagering game is able to build streaks of successful predictions independently from winning or losing the Texas Hold 'Em poker hands. In one embodiment, a successful prediction for the player in the streak wagering game may specifically include meeting common criteria of “not losing to the dealer”; a TIE game outcome may occur when the player and dealer have identically ranked hands. In this example, the TIE game outcome may cause the streak wagering game to perform additional processing, for example, increasing a multiplier or granting an award. Another possibility involves a TIE game outcome not breaking the streak, but also not extending the streak. In all of these cases, specific streak wagering game processing may be required.

In a more general sense, each ancillary game (e.g., hand or round) is used to generate a series of game outcomes. Each player of the streak game is given an opportunity to generate a streak of successful events that result in a corresponding award when the streak game concludes. The successful events may be successful predictions of a game outcome state of the ancillary game, or alternatively, exceeding a predetermined minimum threshold of one or more variables or states in the ancillary game. The longer the streak of successful events generated by the player, the higher the payout of the streak game.

In one embodiment, the ancillary game has outcomes that include a number of states that the player may specifically choose as a prediction, but the ancillary game may have additional outcome state(s) that the player is unable to select as a prediction. As a general rule, if the ancillary game (e.g., hand or round) concludes having a game outcome state unavailable for the player to choose, the player is not penalized even though the prediction may not be successful. Other conditions may result in response to ancillary game outcomes being non-selectable states, including increasing a multiplier for the award of the streak wagering game, other modifications to one or more pay table entries for the streak wagering game, or an increase to a community jackpot, for instance.

### Streak Wagering Game

There is a defined relationship between the ancillary game and the streak wagering game that dictates how the game outcome of the ancillary game impacts the ultimate outcome of the streak wagering game. The streak wagering game may be constructed such that the game outcomes of the ancillary game are similar or identical to the selectable predictions. Alternatively, the selectable predictions of the ancillary game may be abstracted or renamed such that the selections made by a player for the streak wagering game are readily identifiable based on the game outcome of the ancillary game, but may not be identical. From a player perspective, the streak wagering game provides a clear and unambiguous relationship between the game outcome of the ancillary game and determining success within the streak wagering game. In some embodiments, this may be a WIN/LOSE condition determination where no option or selection is provided to the player; the player must WIN in the ancillary game to continue a streak. In other embodiments, the player prediction relating to the ancillary game may be completely unrelated to a WIN/LOSE outcome of the ancillary game, for example, by predicting whether the last card played in the ancillary game will be RED or BLACK.

The streak wagering game as described may be played simultaneously with player participation in the ancillary game, or may be separately operated. The game outcome of the ancillary game may be observed by the player, and may have varying effects on the player outside of the streak wagering game. The invention includes any level of combined interaction between the ancillary game and the streak wagering game. A player may participate fully in the ancillary game (be an active wagering player, making selections, initiating dealing or game start, etc.), have partial participation in the ancillary game (e.g., wagering or commenting on other players and current gameplay), or have no active participation in the ancillary game (only an observer).

The gaming system operating to perform the streak wagering game, optionally in addition to the ancillary game itself, may include a number of different embodiments of specialized computerized hardware and software that operate cooperatively to achieve the described methods and processes detailed below. In one embodiment, a gaming machine 10 communicating with the external system(s) 60 contains the game-logic circuitry 40 (as illustrated in FIG. 2); in other embodiments, the game-logic circuitry 40 is wholly contained in the external system(s) 60. Any suitable division of functional behavior of one or more of the specialized computing units may be employed in one or more locations, remote to or collocated with other functional components of the gaming system.

Thus, the functionality of the gaming machine 10, components of the gaming system that the gaming machine 10 is coupled, and the system as a whole, are variable and mutable, and should not be held as specifically limiting or required for understanding or implementation of the invention as described.

For example, in one embodiment, the gaming machine 10 is a mobile device that connects to an external back end server system 60, and the gaming machine 10 is used to accept input from a player, transmit the input signals to the server, receive image information for the wagering game(s), and display the information to the player via the mobile device. In some embodiments, the gaming machine 10 is considered part of the gaming system as a whole, and in other embodiments, the gaming machine 10 connects to a gaming system only to send or receive information to components of the gaming system.

In another embodiment, the streak wagering game may run on the same platform as the ancillary game, for example, on an electronic gaming table or as a component of a shared community display device. In yet another embodiment, the streak wagering game may be performed completely independently from the ancillary game, where the ancillary game is played with physical components, including cards, dice, balls, etc. The ancillary game may have game outcomes and conditions that are detected and reported using one or more forms of electronic input. Various types of electronic input may be used to report game outcomes, including manual input from a game operator, still or video cameras with image recognition, sensors, radio-frequency identification (RFID) chips, etc.

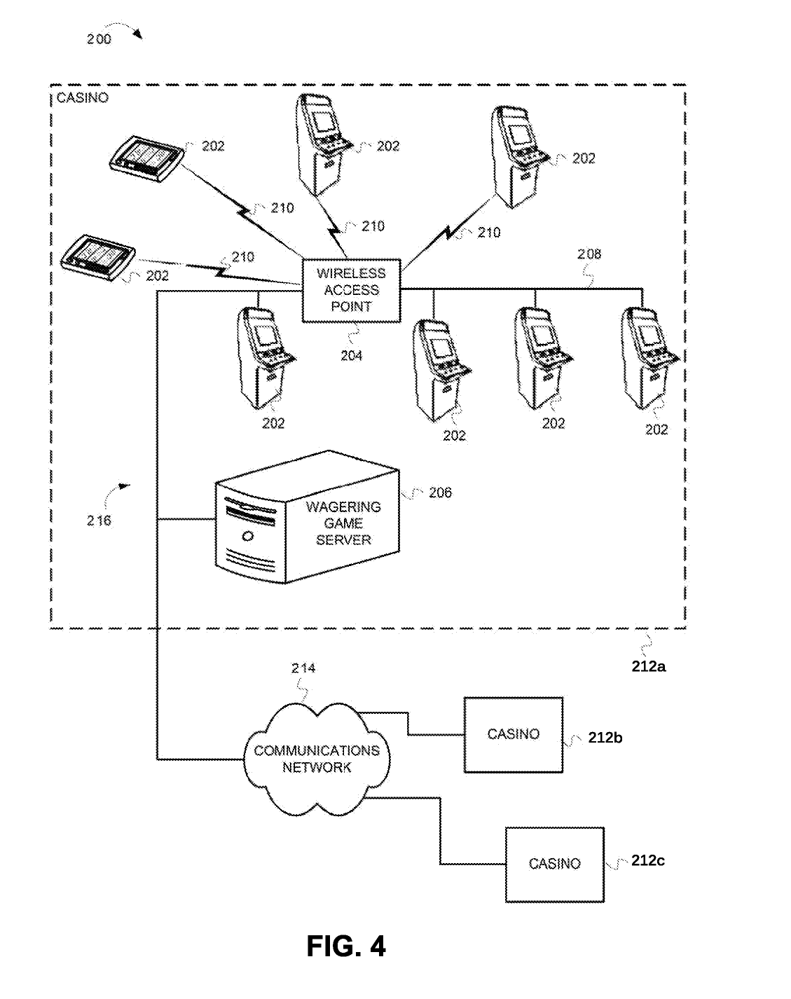

FIG. 4 is a block diagram illustrating a wagering-game system 200, according to one embodiment of the invention. Other combinations of components and specialized computing hardware, all configured with corresponding software, firmware, or a combination of both may also make up the composition of the wagering-game system 200. For example, all the functional elements of the invention may also be implemented in a single secure gaming cabinet and presented on a display screen or gaming table. Any of the wagering game network components (e.g., the wagering-game machines 202) may include hardware and machine-readable media including instructions for performing the operations described herein.

As shown in FIG. 4, the wagering-game system 200 includes a plurality of casinos 212a, 212b, 212c connected to a communications network 214. Each casino 212a-c includes a local area network 216, which includes an access point 204, a wagering-game server 206, and wagering-game machines 202. The access point 204 provides wireless communication links 210 and wired communication links 208. The wired and wireless communication links can employ any suitable connection technology, such as Bluetooth, 802.11, Ethernet, public switched telephone networks, SONET, etc. In some embodiments, the wagering-game server 206 can serve wagering games and distribute content to devices located in other casinos 212 or at other locations on the communications network 214.

The wagering-game machines 202 described herein can take any suitable form, such as floor standing models, handheld mobile units, bartop models, workstation-type console models, electronic gaming tables, etc. Further, the wagering-game machines 202 can be primarily dedicated for use in conducting wagering games, or can include non-dedicated devices, such as mobile phones, personal digital assistants, personal computers, etc. In one embodiment, the wagering-game system 200 can include other network devices, such as accounting servers, wide area progressive servers, player tracking servers, and/or other devices suitable for use in connection with embodiments of the invention.

In some embodiments, wagering-game machines 202 and wagering-game servers 206 work together such that a wagering-game machine 202 can be operated as a thin, thick, or intermediate client. For example, one or more elements of game play may be controlled by the wagering-game machine 202 (client) or the wagering-game server 206 (server). Game play elements can include executable game code, lookup tables, configuration files, game outcomes, audio or visual representations of the game, game assets or the like for both the ancillary game and/or the streak wagering game. In a thin-client example, the wagering-game server 206 can perform functions such as determining game outcomes for the ancillary game and/or the streak wagering game in addition to managing assets, while the wagering-game machine 202 can present a graphical representation of such outcomes or asset modification to the player. In a thick-client example, the wagering-game machines 202 can determine game outcomes and communicate the outcomes to the wagering-game server 206 for recording or managing a player account.

In some embodiments, either the wagering-game machines 202 (client) or the wagering-game server 206 can provide functionality that is not directly related to game play. For example, account transactions and account rules may be managed centrally (e.g., by the wagering-game server 206) or locally (e.g., by the wagering-game machine 202). Other functionality not directly related to game play may include power management, presentation of advertising, software or firmware updates, system quality or security checks, etc.

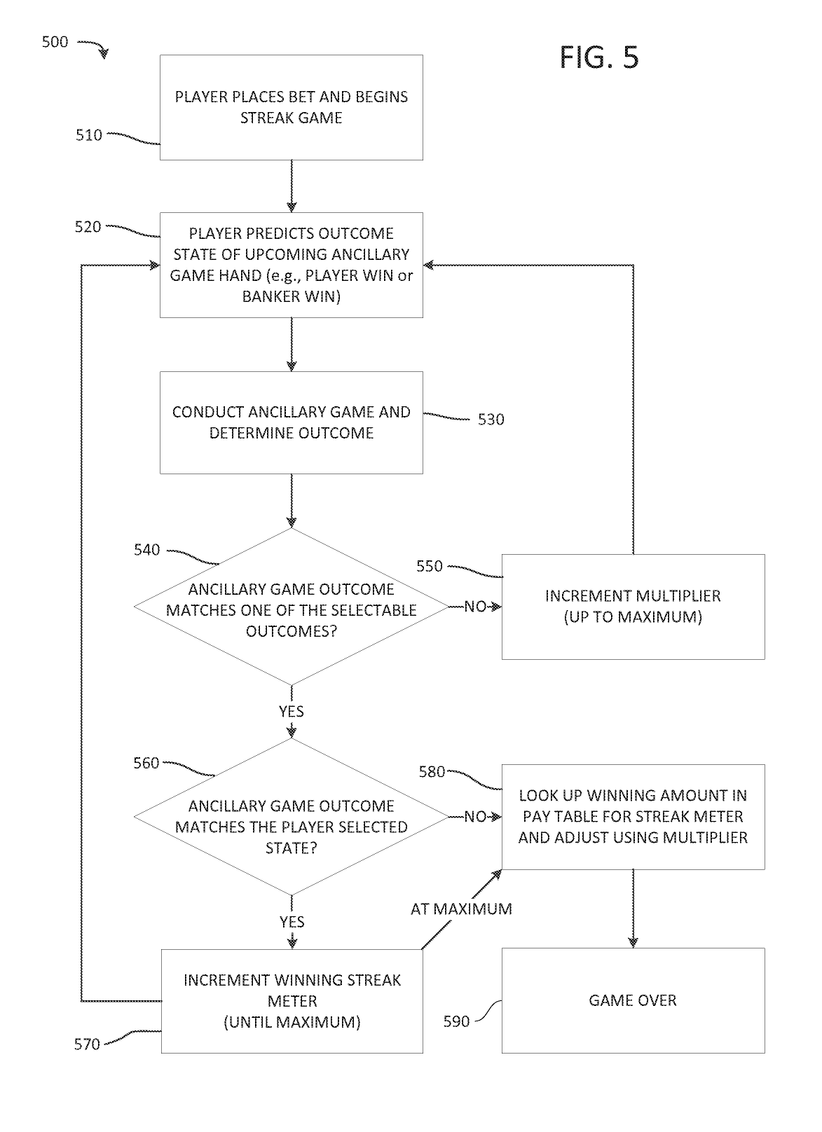

In FIG. 5, a flow chart for a process 500 for controlling a wagering-game system to perform one embodiment of the streak wagering game is provided. The wagering-game system performing process 500 may include one or more servers coupled to a network for communication, one or more client devices interfacing with one or more players, and any number of intermediately positioned machines that facilitate the method as described.

In step 510, the player places a wager to start a streak wagering game at a given wager amount. This wager amount is deducted from the player's credit meter. In response, the streak wagering game is initiated and begins.

In step 520, the player is prompted to select the game outcome of an upcoming game (e.g., hand or round) of another, ancillary game that may or may not be a wagering game. In one embodiment, this ancillary game is Baccarat as detailed below. The player will be predicting a game outcome of the ancillary game, in the case of Baccarat, whether a PLAYER WIN or a BANKER WIN occurs. This may involve a configurable game timer (e.g., starting with 15 seconds) to allow the prediction to be made by the player. Using a user interface (e.g., buttons or a graphical user interface), the player may toggle between the game outcome prediction selections until the timer expires, and the prediction will then be locked in for the next ancillary game outcome (e.g., Baccarat hand).

Alternatively, the player may decide to decline to predict a game outcome for the upcoming ancillary game, resulting in a suspension of the streak wagering game until a suitable prediction is made. As this occurs, the streak wagering game will resume once a prediction has been chosen and an ancillary game round has begun. Thus, a player may “sit out” or delay participation in the streak wagering game while the ancillary game continues, whether or not the player is an active participant in the ancillary game.

In step 530, the ancillary game is conducted, and the game outcome for the ancillary game is determined. In one embodiment, the Baccarat Dealer conducts the Baccarat hand using the rules of Baccarat detailed below and the game outcome of the Baccarat hand is fully determined. In this embodiment using Baccarat, the game outcomes used by the streak wagering game include PLAYER WIN, BANKER WIN, and TIE.

In step 540, a determination is made as to whether the ancillary game outcome matches any of the options available to the player during the prediction phase (step 520). In the current embodiment, one specific game outcome that does not match any of the options available to the player includes a TIE determined in the ancillary game. This is a base outcome of the ancillary game that cannot be otherwise joined with the other prediction options presented to the player, and so, the player is not penalized for predicting incorrectly. Instead, in this embodiment, a multiplier value is increased up to a predetermined maximum value.

In other embodiments, an ancillary game outcome unavailable for predictive selection may include a specific game total outcome (e.g., Ace+Jack “blackjack”, dice “snake-eyes”, or a poker “Royal Flush”), a comparative determination (e.g., “Jacks or better”), or a “bonus game trigger”, for instance. Typically, the game outcome prediction options made by the player will be made from reasonably similar game outcomes (e.g., WIN or LOSE, BANKER WIN or PLAYER WIN, HOUSE WIN or PLAYER WIN, BLACK or RED, EVEN or ODD, etc.), with an additional limited number of game outcomes not included in the selectable game outcomes (e.g., TIE, GREEN, or ZERO/DOUBLE-ZERO).

Step 550 is performed when it is determined that the ancillary game outcome does not match either of the predictive choices available to the player at the time of selection. In one embodiment, this equates to a TIE in an ancillary Baccarat game. In response, a multiplier value is incremented if the current multiplier value is below a maximum value. The value and effect of the multiplier value is specific to implementation. For example, incrementing the multiplier value may advance the player toward a predetermined multiplier maximum. Alternatively, each increment of the multiplier value may indicate half a full multiple of the pay table award that is only adopted when a full multiple is achieved. In yet another embodiment, only sections of the pay table, or a specified subset of entries thereon, may increase by a multiple or a fixed amount. In this way, a wide variety of combinations for enhanced pay table awards may be achieved.

Further, a multiplier may default to a given value of one at the beginning of the streak wagering game, but other embodiments may require an initial increment to ensure an award. For example, if a player begins a streak wagering game with a zero multiplier, it will be necessary to raise the multiplier above zero to receive a payout. Thus, as the ancillary game outcomes dictate, the multiplier value is increased accordingly. In the event that an increase of the multiplier value exceeds a predetermined maximum value for the multiplier value, no further increase of the multiplier value will occur. That is, when the maximum multiplier value is achieved, all further game outcomes of this type result in a null event, causing no increase in the multiplier value.

In this embodiment, when the ancillary game outcome does not correspond to any of the prediction options available to the player, the player streak is not considered broken and the process returns to step 520 where the player continues trying to increase the winning streak by correctly predicting the game outcome of future ancillary game hands.

In other embodiments, the ancillary game outcome may simply cause a “push”, requiring no additional processing or other effect whatsoever, simply returning the state of the streak wagering game to step 520 prompting the player for a prediction selection for an upcoming game outcome. The implementation of a multiplier value that alters the pay table the streak wagering game is not required for the invention as a whole. However, the inclusion of a multiplier provides an opportunity to create an enhanced excitement and alternative to the player, above and beyond to the basic operation of the invention of determining accurate predictions.

In step 560, if the ancillary game outcome does match a prediction option that was available to the player during the prediction phase (step 520), a determination is made as to whether the player predicted the game outcome state matching the ancillary game outcome.

In step 570, when it is determined that the ancillary game outcome matches the player prediction, a streak meter is incremented. In the event that the streak meter is valued high enough to have a payout in the pay table, this value may be reflected in a corresponding win meter, potentially adjusted by any gained multipliers (detailed below). In the event that the new value of the streak meter is equal to a maximum streak meter value, the process continues at step 580 where the streak wagering game ends and the player is awarded the highest payout in the pay table. Otherwise, when the new value for the streak meter is below the maximum meter value defined in the pay table, the process returns to step 520, where the player selects another ancillary game outcome state to continue building a winning streak for larger pay table rewards.

Step 580 is performed when the player prediction fails to match the game outcome of the ancillary game. This indicates that the streak wagering game will end because the winning streak has been broken. Step 580 is also performed when the streak meter is determined to be at the highest value possible, wherein any further successful predictions will not increase the streak meter. This indicates the player will be awarded the highest prize available in the pay table because there is no higher achievement available for improving the winning streak.

As part of step 580, a payout amount corresponding to the value of the streak meter is determined from the pay table and this value is adjusted by the current multiplier. In the event that the multiplier was not incremented during gameplay in step 550, the payout amount specified in the pay table is unchanged. In one embodiment, in the event that the multiplier value increases once during gameplay in step 550, the multiplier becomes two causing the resulting payout amount to be doubled. In on embodiment, the multiplier of the streak wagering game is limited to 5× (i.e., five-times), limiting the maximum pay table payout value.

In step 590, the streak wagering game ends. At this point, a payout of the streak wagering game is accounted to the player's credit meter prior to, or simultaneously with, the termination of the streak wagering game. The player may return to step 510 and is given an opportunity to place an additional wager to play the streak wagering game again.

As can be seen, the streak wagering game enhances performance and efficiency of the wagering-game system by providing a secondary wagering game that does not require further invocation of a random number generator function. That is, the underlying ancillary game necessarily requires one or more random number generator calls that may be computationally demanding on the wagering game equipment; further and additional random number generator calls are not required to actively and simultaneously perform one or more of the streak wagering games as detailed above. This extended utilization of the individually generated random numbers (already performed and occurring for determining the outcome of ancillary games) is leveraged to determine additional secondary gaming outcomes, such as the streak outcomes, without additional computational overhead. Thus, more wagers and wagers of differing types can be applied to the same number of random element generations, thereby increasing wager throughput without the negative consequence of increasing computational workload involving one or more random-element generator(s) or any additional random number generation. This improves the efficiency of any electronic device active in performing the streak wagering games as presented (e.g., wagering-game machines 202), in addition to the system as a whole (e.g., wagering-game system 200).

The ancillary game specifically uses one or more random elements generated by a random element generator to determine an outcome for the ancillary game. In the ancillary game, random elements may additionally provide a tangible award in response to an outcome meeting predetermined criteria. The outcome of the streak wagering game (i.e., the value of the streak meter) necessarily involves one or more outcomes of the ancillary game that are determined randomly. Thus, one or more random elements used for the ancillary game contribute to, and ultimately determine, the value of the streak meter at the conclusion of the streak wagering game. The provision for the repeated use of the same one or more random elements for use in simultaneous wagering game increases the efficiency and capability of the wagering game systems at large, and are advantageous for the ability to perform such additional wagering gaming functions without any additional random elements

### Example Ancillary Game: Baccarat

A description for an example ancillary game, Baccarat, is now provided. Using Baccarat as the ancillary game for the streak wagering game, outcome states can be generated for the streak wagering game as described above.

The game of Baccarat is a gambling game played for high stakes in many parts of the world. While there may be many variants for the game of Baccarat, one specific variant of the game will be detailed below for use as the ancillary game. Additional variants of Baccarat may also include differing selection of the BANKER and PLAYER, in addition to modifications to the conditions that result in additional cards being dealt. It should be understood any variant of Baccarat may be used in conjunction with the described streak wagering game, even in cases when there are substantial differences between the following description and the given variant specifically implemented.

Baccarat is played using a set of decks of standard playing cards (i.e., 52 cards comprising 13 cards numbered Ace-King in four distinct suits). While conducting Baccarat, the cards Ace through Nine are each worth their face value and the cards Ten, Jack, Queen, and King are each worth zero points. A Baccarat hand is evaluated as the sum modulo ten of its cards, i.e., only the last (ones) digit of the summed total is considered. The object of the game is to obtain a hand as close to eight or nine as possible consisting of two cards, or as close to nine as possible with at most three cards (if one does not have eight or nine on his first two cards). After a third card is dealt for each hand, in accordance with particular rules of the game, and the highest valued hand wins the round once any addition cards are distributed, if necessary.

A “BANKER” and a “PLAYER” are chosen for the Baccarat game. The selection of players for these roles does not impact game play. In some cases, no BANKER or PLAYER actually exists, and the cards are laid out in fields used to designate the two card sets. In some cases, the BANKER retains the shoe and deals cards for the Baccarat hands as long as the bet “BANKER WINS” does not lose. In the event of a TIE, players may be allowed to alter their bets, and the same BANKER deals cards for an additional hand. When the bet “PLAYER WINS” wins, the shoe may move to a new BANKER, for example, the adjacent player on the right.

Generally, there are two principal wagers which can be placed by players (or observers) during the Baccarat game, “BANKER WIN” and “PLAYER WIN.” Any player participating in the Baccarat game may make either of these bets before the beginning of any round of play. Other wagers which may be made by active participants in the Baccarat game may include “TIE”, as well as bets on a PLAYER revealing a pair of cards, a BANKER revealing a pair of cards, or whether a “natural” occurs (explained below).

Once the PLAYER and the BANKER are determined and all bets are placed, the PLAYER and the BANKER are dealt two cards each to begin the hand, and the cards are revealed for all to see.

As noted above, the cards Ace through Nine are worth face value and Tens and Face Cards are worth zero points during summation. Only the last digit in the total is considered (i.e., sum modulo 10), specifying the score of the hand. For example, if the PLAYER revealed two cards, an Eight and a Seven, then the PLAYER hand total would be fifteen, and the PLAYER hand score would be a five. The scores for every hand will always range from zero to nine, and it is impossible to “bust” (exceed a total which causes the hand to lose). If either two-card total equals eight or nine (this is called a “natural eight” or a “natural nine”, respectively), all bets are settled at once and the hand is immediately over.

If neither the PLAYER nor the BANKER has a natural, the PLAYER and the BANKER then draw or stand according to a predetermined set of rules. These rules typically include an overriding rule dictating that if either the PLAYER or the BANKER has a natural (i.e., total of an eight or nine) they both stand. Other rules include if the PLAYER total is five or less, then the PLAYER receives another card, otherwise the PLAYER total is directly determined. If the PLAYER stands, then the BANKER hits on a total of five or less. If the PLAYER receives a card, a chart (TABLE 1) is used to determine whether the BANKER receives a third card (H) or stands (S). It is important to note that TABLE 1 dictates that the BANKER receives a third card as a result of the value of the PLAYER's third card, not the PLAYER's hand total.

TABLE 1

| | PLAYER’S THIRD CARD | | | | | | | | | | |
|---|---|---|---|---|---|---|---|---|---|---|---|
| BANKER’S | | 0 | 1 | 2 | 3 | 4 | 5 | 6 | 7 | 8 | 9 |
| SCORE | 7 | S | S | S | S | S | S | S | S | S | S |
| | 6 | S | S | S | S | S | S | H | H | S | S |
| | 5 | S | S | S | S | H | H | H | H | S | S |
| | 4 | S | S | H | H | H | H | H | H | S | S |
| | 3 | H | H | H | H | H | H | H | H | S | H |
| | 2 | H | H | H | H | H | H | H | H | H | H |
| | 1 | H | H | H | H | H | H | H | H | H | H |
| | 0 | H | H | H | H | H | H | H | H | H | H |

After any third card(s) are dealt, the total of the PLAYER hand and the BANKER hand are compared. The winner of the hand is the player with the hand having the greater value. If the hands are equal, a TIE is declared and TIE wagers are settled. In one embodiment, the end result of each ancillary game of Baccarat ends in either a TIE, or one of two other states, PLAYER WIN or BANKER WIN. In the case of a TIE, PLAYER WINS and BANKER WINS bets are not considered losses, and outstanding wagers are able to be modified in any desired manner prior to the beginning of the next hand.

The game outcomes of an ancillary Baccarat game may be used to allow players of the streak wagering game to track winning streaks of successful events, for example, by incrementing a count of successful predictions or a count of successful wins. This may be done using a variety of user interfaces, the details of which are purposefully omitted for the sake of brevity. In some cases, these user interfaces include graphical user interfaces present on a digital table where the ancillary Baccarat game is digitally displayed, or on a mobile or handheld device capable of displaying imagery and receiving input.

Baccarat may also be implemented using a computer suitably programmed to perform operation of the game, presentation, gathering and processing input from the player, determining compared outcomes and predictions, generating graphical and audio output for the player, and using one or more random numbers for card randomization. The provision for still and video cameras, in combination with image recognition to determine physical cards in play may provide another way to digitally provide game outcomes of Baccarat as an ancillary game used for the streak wagering game as described.

As mentioned prior, the specific ancillary game may be any form of game, wagering or not, including card games, dice games, and video or mechanical games. The ancillary game is required to provide or result in at least one form of electronic input for digitally reporting game outcomes of the ancillary game that are used to compare and define game outcomes for the streak wagering game. Additionally, the presented selection(s) of the game outcomes of the ancillary game, if any, and the resolving of accurate prediction or winning conditions as a player streak is formed, is highly variable and dependent upon the type of ancillary game being used and the corresponding options of the streak wagering game available to the player.

Multiple players may simultaneously take part in their own streak wagering games, independently from each other, even while using identical ancillary game outcomes to determine prediction streaks. In one embodiment, a single Baccarat hand may occur and be administered by a centralized computer controller or server and be distributed to all players participating in the streak wagering game during that hand.

Further, a single player may be simultaneously enrolled in multiple streak wagering games that were started at varying times during the streaks. Typically, the player may select to place a wager and begin another instance of the streak game (i.e., step 510) prior to an upcoming ancillary game outcome. In this way, a player may simultaneously participate in any number of streak wagering games that begin asynchronously. Further, other players may asynchronously begin new streak wagering games at any time during other independent streak wagering games that other players are active in.

Each streak wagering game result for each player may be published to all participating players, optionally showing the predictions of each player and the value of their current streak. In one embodiment, all player information is anonymous, and simply identifies each player solely by the length of their respective streak. This may enable players to examine the selection that the more successful players are making, potentially influencing other player's choices made in upcoming plays. In one embodiment, a player may be identified by a session number, username, or other (random or chosen) designation, allowing maintenance and rankings of players to identify specific players who routinely achieve long streaks or have an above average winning percentage.

Similarly, in another embodiment, a community display is provided which displays the deal, play, and outcome of the ancillary game (e.g., Baccarat hands), in addition to or separate from a presented visual interface displaying ancillary game events and game outcomes. Interfaces may include graphical presentations used by a player to examine prior ancillary game events (e.g., Baccarat hand tables and shoe histories). An interface may also include or identify streaks and current selections made by other players.

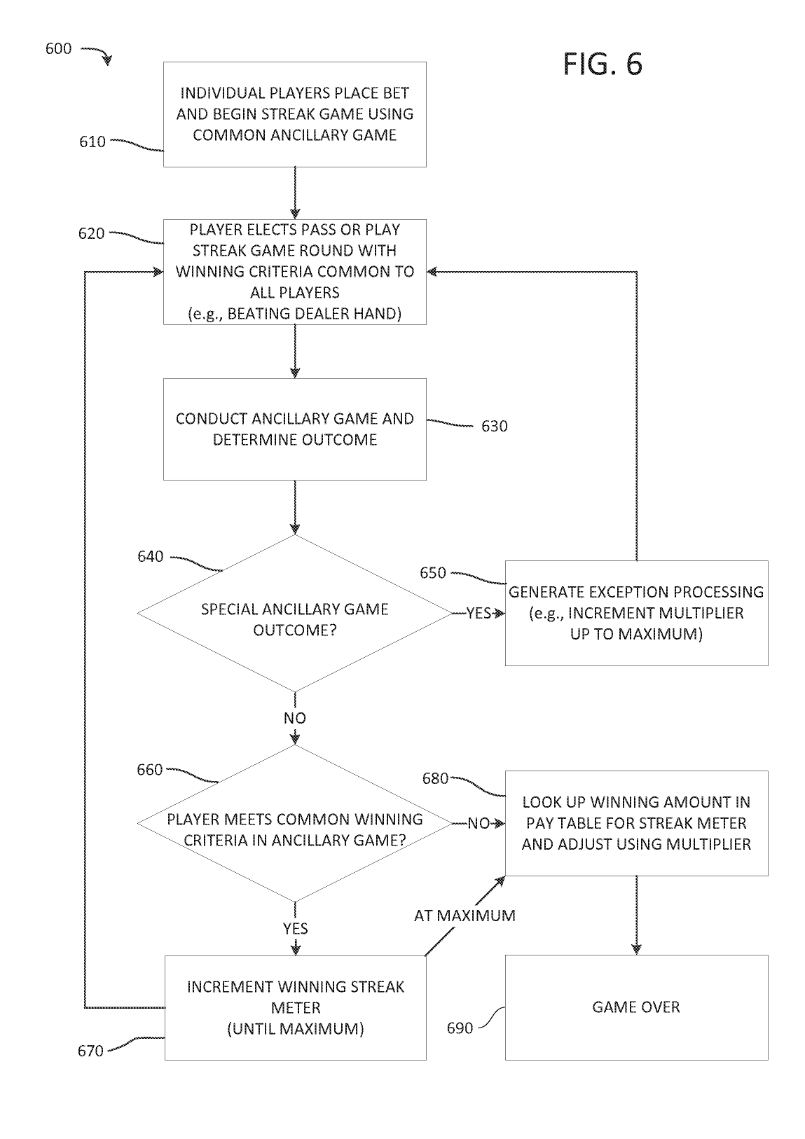

In FIG. 6, a flow chart for a process 600 is shown for providing a number of simultaneous streak wagering games played by a plurality of players while using a common ancillary game.

It is noted that each player may independently participate in the ancillary game during the one or more streak wagering game(s) being performed. A player may also be simultaneously engaged in multiple streak wagering games, and have numerous outstanding wagers, each independent from the others, including any potential wagers in the ancillary game.

In step 610, each player places a wager to start the streak wagering game at a given wager amount when initiating the wagering game for themselves. Upon initiation, the appropriate wager amount is deducted from the player credit meter, and the streak wagering game begins for the player.

As mentioned prior, at specific times, a player may be given an opportunity to specify a wager and initiate another streak wagering game in addition to a streak wagering game already in progress. In this scenario, plural flows of FIG. 6 may occur in parallel as the player performs actions in each of the independent streak wagering games. The operation of each streak wagering game instance is completely independent from all the others.

Each player will perform the remainder of the process 600 independently from the other players participating in their own streak wagering game. This allows players to collectively play the streak wagering game asynchronously, joining at any time, even during a long and successful streak of another player. As players conclude the streak wagering game (i.e., breaking their streaks, cashing out, or winning a top prize), the players may play the streak wagering game again without any perceived disruption to themselves or others. Further, players may choose to suspend the streak wagering game by opting to temporarily stop playing the streak wagering game. Mechanisms to pause game play may be a result of activation of a special button or menu selection, or failure to make a prediction during a specified time period. Players may rejoin gameplay at any time in the future by resuming their participation in the streak wagering game. Thus, a player could decide to play only a specific set of rounds of the streak wagering game (e.g., every third hand), independently from any level participation in the ancillary game (e.g., playing every hand, or even no hands).

In one embodiment, a community display is also generated that shows some or all of the currently participating players, along with their corresponding streak-count meter. Alternatively, if a player has predicted an ancillary game outcome (as in FIG. 5, step 520), this may also be displayed. This allows participating players to observe the streaks (and predictions) of other players simultaneously active in the streak wagering game.

In some embodiments, a backend computing server of the wagering-game system (e.g., external system 60 or wagering-game server 206) may perform the operation of the ancillary game, the streak wagering game, or both. In one embodiment, a player participates in the streak wagering game using a mobile device, such as a phone or handheld computer, coupled to the gaming system to receive and forward input and relay and display output, between the player and a network gaming server. The inclusion of a community display as noted above may reflect information associated with one, all, or none of any client device coupled to the system, mobile or not. The gaming system is able to simultaneously provide gameplay and functional interaction between the components of the gaming system, system clients, and third party applications or devices in a purely asynchronous manner.

One or more players may also be active players in the ancillary game independently from any interaction in the streak wagering game(s). It is also possible for a player to have multiple participations in the ancillary game (for example, playing multiple simultaneous independent Blackjack hands). Thus, wagers, outcomes, determination, payouts, etc., from the ancillary game instances and multiple streak wagering games are separately determined.

In step 620, each individual player is prompted to select PASS or PLAY from a suitable menu of the streak wagering game. This selection may be optional, not giving the player an option to delay or otherwise suspend gameplay as the ancillary game continues. At this time, the interface generally displays any winning common criteria that will be used by all the players in the game to determine whether the streak for each player will continue or end when each outcome of the ancillary game is determined.

For example, in an exemplary streak wagering game using an ancillary Texas Hold 'Em poker game, a randomly generated hand for a dealer (or other common opponent) may be specified that is used to compare with the poker hand outcome of each player as the ancillary game concludes. Another example may include the player being given a predetermined poker hand rank threshold to meet or exceed to be considered successful, like three-of-kind. When the ancillary game poker hand concludes, all player hands are commonly judged against these common criteria to determine whether each player continues or ends their corresponding streak.

In step 630, the ancillary game is conducted and the game outcome for the ancillary game is determined. In one embodiment, this includes the execution and conclusion of the Texas Hold 'Em poker game, where all betting and results from that wagering game are settled independently from the streak wagering game.

In step 640, a determination is made as to whether the ancillary game outcome matches one or more “special” outcomes that will result in additional processing. When in use, a list of predefined outcomes or conditions is specified to trigger the additional processing. For example, a list of this type may include an outcome where the player TIES the common dealer hand, and a WIN or LOSS is undeterminable. Other special game outcomes may include specific conditions of the ancillary game, such as dice rolling “snake-eyes”, the playing of the Ace of Spades triggering an increase in the payout multiplier, or obtaining an outcome having a predefined hand rank entitling an additional award or benefit (e.g., a Royal Flush).

Step 650 is performed when it is determined that there is a special ancillary game outcome, and any associated additional processing will be performed. In one embodiment, in response to a specific outcome a multiplier value may be increased up to a predetermined maximum value. Processing may also include granting a distinct or bundled award, perhaps accounted directly to a player credit meter during the streak wagering game.

After any exception processing is performed in response to any predefined ancillary game outcomes, process flow returns to step 620 where the streak wagering game continues.

In step 660, if the wagering game outcome is not a predefined game outcome requiring exception processing, a determination is made as to whether the corresponding player has met the common criteria required to continue their streak. As detailed above, a comparison is made to determine whether the ancillary game outcome for the player meets or exceeds the common criteria defined for the streak wagering game round, for example, a dealers hand, a predetermined total or result for the hand, etc. The common criteria may include a determination of achieving an award above a predetermined amount (e.g., zero credits) in the ancillary game, enabling the system to track streaks of wins of ancillary game play.

In step 670, when it is determined that the ancillary game outcome for the player meets the common criteria, the streak meter for that player is incremented (or otherwise increased by some amount). In the event that the streak meter is valued high enough to have a payout in the pay table, this value may be reflected in the corresponding win meter for the player.

In the event that the new value of the streak meter is equal to a maximum streak meter value, the process continues at step 680 where the streak wagering game ends and the player is awarded the highest payout in the pay table. Otherwise, when the new value for the streak meter has not yet exceeded the maximum meter value defined in the pay table, the process returns to step 620 permitting the player to continue their streak.

Step 680 is also performed when the player fails to achieve the common criteria, thereby terminating their successful streak. As part of step 680, a payout award amount corresponding to the value of the streak meter is determined from the pay table and this value is adjusted by the current multiplier, if existent.

In step 690, the streak wagering game ends. At this point, a payout of the streak wagering game is accounted to the player's credit meter prior to, or simultaneously with, the termination of the streak wagering game. The player may be given an opportunity to return to step 610 and place an additional wager to play the streak wagering game again.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A gaming system primarily dedicated to playing a regulated casino wagering game including predicting outcomes of an ancillary game, the gaming system comprising:
an input interface for receiving input signals via a communications network;
an output interface for transmitting output signals via the communications network;
a random element generator configured to generate one or more random elements; and
game-logic circuitry configured to:
in response to receiving, via the input interface, a wager input signal indicative of a wager by a player, initiate the casino wagering game;
receive, via the input interface, a selection input signal indicative of a selection of a predicted outcome of the ancillary game, the predicted outcome selected from a plurality of potential outcomes of the ancillary game;
determine an outcome of the ancillary game based, at least in part, on the one or more random elements, and transmit, via the output interface, game data representing the outcome of the ancillary game for display on a remote device;
in response to the predicted outcome matching the determined outcome, increment a streak counter and transmit, via the output interface, game data representing an increased value of the streak counter for display on the remote device; and
in response to the predicted outcome not matching the determined outcome, grant an award to the player in response to meeting a predetermined award criterion for a value of the streak counter during conclusion of the casino wagering game.

2. The gaming system of claim 1, wherein the game-logic circuitry is further configured to increase a multiplier in response to the determined outcome being a predetermined outcome of the ancillary game, and adjusting the granted award based, at least in part, upon the value of the multiplier.

3. The gaming system of claim 1, wherein the player is one of a plurality of players engaged in a plurality of concurrent corresponding casino wagering games based on the same ancillary game.

4. The gaming system of claim 3, wherein the matching of the predicted outcome to the determined outcome is independently determined for each of the plurality of players using common criteria.

5. The gaming system of claim 3, further comprising a community display device configured to display the predicted outcomes and the streak counter values of at least two of the plurality of players.

6. The gaming system of claim 1, wherein the game-logic circuitry is further configured to suspend conducting the casino wagering game prior to receiving the selection input signal and resume conducting the casino wagering game when the selection input signal is received.

7. The gaming system of claim 1, wherein the determined outcome and the increased value of the streak counter are based, at least in part, on the same one or more random elements.

8. A gaming system primarily dedicated to conducting a first and a second regulated casino wagering streak game using outcomes of a common ancillary game, the gaming system comprising:
at least one input interface for receiving first input signals and second input signals;
at least one output interface for transmitting output signals to one or more electronic display devices;
a random element generator configured to generate one or more random elements; and
game-logic circuitry configured to:
in response to receiving, via at least one of the input interfaces, a first input signal indicative of a first wager by a first player, initiate the first regulated casino wagering streak game;
in response to receiving, via at least one of the input interfaces, a second input signal indicative of a second wager by a second player, initiate the second regulated casino wagering streak game;
determine an outcome of the ancillary game based, at least in part, on the one or more random elements, and transmit, via the at least one output interface, game data representing the outcome of the ancillary game for display on the one or more electronic display devices;
in response to the determined outcome meeting a first predetermined success criteria, increment a first streak counter having a first value representing a current streak for the first player and transmit, via the at least one output interface, game data representing the first value for display on the one or more electronic display devices;
in response to the determined outcome meeting a second predetermined success criteria, increment a second streak counter having a second value representing a current streak for the second player and transmit, via the at least one output interface, game data representing the second value for display on the one or more electronic display devices;
in response to the determined outcome not meeting the first predetermined success criteria and the value of the first streak counter meeting a predetermined award criterion, grant an award to the first player based on the value of the first streak counter; and
in response to the determined outcome not meeting the second predetermined success criteria and the value of the second streak counter meeting a predetermined award criterion, grant an award to the second player based on the value of the second streak counter.

9. The gaming system of claim 8, wherein common criteria is used to independently determine whether the determined outcome meets the first and second predetermined success criteria for the first player and the second player, respectively.

10. The gaming system of claim 8, wherein the game-logic circuitry is further configured to direct the one or more electronic display devices to display the streak counter values of the first and second players.

11. The gaming system of claim 8, wherein the game-logic circuitry is further configured to perform exception processing for the first player and the second player in response to a predetermined determined outcome.

12. The gaming system of claim 8, wherein at least one of the first player and the second player is an active participant in the common ancillary game.

13. The gaming system of claim 8, wherein the first player is an active participant in a plurality of independent first regulated casino wagering streak games based on the common ancillary game.

14. The gaming system of claim 8, wherein the game-logic circuitry is further configured, in response to receiving a suspension input, via one of the at least one input interfaces, suspending the first regulated casino wagering game for the first player prior to determining the outcome of the ancillary game, and in response to receiving a resumption input, via one of the at least one input interfaces, resuming the first casino wagering game.

15. A method of operating a gaming system primarily dedicated to playing a regulated casino wagering game, the gaming system including a secure gaming server, a random element generator, game-logic circuitry, an input interface for receiving input signals, and an output interface for transmitting output signals, the method comprising:
generating one or more random elements with the random element generator;
receiving, via the input interface, a wager input signal indicative of a wager by a player;
receiving, via the input interface, a selection input signal indicative of a selection of a predicted outcome of an ancillary game, the predicted outcome selected from a plurality of potential outcomes of the ancillary game;
determining an outcome of the ancillary game based, at least in part, on the one or more random elements, and transmitting, via the output interface, game data representing the outcome of the ancillary game for display on a remote device;
in response to the predicted outcome matching the determined outcome, incrementing, by the game-logic circuitry, a streak counter and transmitting, via the output interface, game data representing an increased value of the streak counter for display on the remote device; and
in response to the predicted outcome not matching the determined outcome, granting, by the game-logic circuitry, an award to the player based on a value of the streak counter at conclusion of the casino wagering game meeting a predetermined award criterion.

16. The method of claim 15, further comprising increasing, by the game-logic circuitry, a multiplier in response to the determined outcome being a predetermined outcome of the ancillary game, and adjusting the granted award based, at least in part, upon the value of the multiplier.

17. The method of claim 15, wherein the player is one of a plurality of players engaged in a plurality of concurrent corresponding casino wagering games based on the same ancillary game.

18. The method of claim 17, further comprising a community display device configured to display the predicted outcomes and the streak counter values of at least two of the plurality of players.

19. The method of claim 15, wherein the determined outcome and the increased value of the streak counter are based, at least in part, on the same one or more random elements.

20. The method of claim 15, further comprising suspending, by the game-logic circuitry, the conduct of the casino wagering game prior to receiving the selection input signal, and resuming, by the game-logic circuitry, conduct of the casino wagering game when the selection input signal is received.
